(19) United States
(12) Patent Application Publication
(10) Pub. No.: US 2014/0260687 A1
(43) Pub. Date: Sep. 18, 2014

(54) ROOF MONITORING METHOD AND SYSTEM

(71) Applicant: Beldon Technologies, Inc., San Antonio, TX (US)

(72) Inventor: Bradford Beldon, San Antonio, TX (US)

(73) Assignee: Beldon Technologies, Inc., San Antonio, TX (US)

(21) Appl. No.: 14/209,819

(22) Filed: Mar. 13, 2014

Related U.S. Application Data
(60) Provisional application No. 61/800,141, filed on Mar. 15, 2013.

(51) Int. Cl. G01L 1/26

(52) U.S. Cl. CPC G01L 1/26
USPC 73/862.381

(57) ABSTRACT

Methods, systems, and apparatus, including computer programs encoded on a computer storage medium, for monitoring a load condition over a specified area In one aspect, a load sensor comprises: a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor.

### CROSS-REFERENCE TO RELATED APPLICATIONS

This application claims priority of U.S. Provisional Application Ser. No. 61/800,141, filed Mar. 15, 2013. The contents of the prior application are incorporated herein by reference in its entirety.

International Publication No. WO 2011/133942 is incorporated herein in its entirety.

### BACKGROUND

This specification relates to a system and method of monitoring loading conditions on a structure. More specifically, this specification relates to a method and system of monitoring roof loading conditions and reporting such conditions to a network or user.

A structural member such as a roof may experience loads due to external forces acting on an exterior surface, such as snow or rain fall, standing water, or wind. Load accumulation may be indicative of other problems, such as ice damming or other accumulation. Sufficient load accumulation may cause the structure to catastrophically fail, thereby endangering occupants.

Structures with large surface areas can experience significant load conditions due to environmental factors. In many areas of the world, snow removal is necessary from the roofs of large structures in order to prevent structural damage and collapse. Snow removal from such structures is labor intensive, dangerous, and expensive. But there is a yet a system or technology to effectively measure various load conditions and report when snow removal or otherwise dangerous loading conditions are present. Moreover, a predictive system that can alert users well before dangerous conditions exist would be desirable along with the ability to monitor such load conditions remotely or from a site removed from the monitored structure.

### SUMMARY

This specification describes technologies relating to remote monitoring of load conditions across a specified area and reporting load conditions over a network.

In general, one innovative aspect of the subject matter described in this specification can be embodied in methods that include the actions of: periodically monitoring the load condition over a specified area using one or more networked load sensors; connecting a load sensor with a local network, receiving at sensor base station a load condition measured by at least one load sensor; processing the load condition and determining whether such load condition is within a specified parameter; reporting the load condition to a user over a network. Other embodiments of this aspect include corresponding systems, apparatus, and computer programs, configured to perform the actions of the methods, encoded on computer storage devices.

In another example embodiment of the present invention a load sensor comprises: a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor.

In yet another example embodiment of the present invention, a system comprises a sensor array having one or more load sensor, wherein the load sensors comprise a protective top cover having a load transfer assembly; a bottom plate attachable to the top cover; the bottom plate including a circuit board comprising; a load sensor, a power source; and a wireless processor; wherein the circuit board is configured on the bottom plate such that the load transfer assembly of the top plate is in contact with the load sensor; the load sensors are in wireless communication with a base station server, wherein the base station server receives periodic load condition reports from the load sensors in the sensor array, processes the load conditions into a user readable report and transmits the user readable report to a user terminal over network. The base station server can also receive instructions or information from terminals via the network; process the information or instructions to reconfigure the operation of one or more sensors in the sensor array; and transmit operating instructions the sensors over a wireless network.

Particular embodiments of the subject matter described in this specification can be implemented so as to realize one or more of the following advantages. A specified area can be monitored for load conditions or other environmental conditions according to a predetermined schedule. Sensors can be programmed to activate, report information, receive information, and deactivate on a preset schedule in order to preserve battery life. Sensors can be interchanged. Load conditions can be monitored on a variable schedule based on information determined by the sensors or on information provided from an outside source. Load conditions can be monitored well before a critical condition occurs. Snow removal from a roof surface can be done based on actual load conditions, preventing unnecessary cost and resource expenditure. Specific areas within a sensor array can be identified as having an alarm condition. Load conditions can be monitored remotely. Sensors can be activated on user command, or in response to an external condition.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example embodiment of a sensor unit of the present invention.

FIG. 2 is a top view of an example embodiment of a sensor unit of the present invention.

FIG. 3 is an internal top view of an example embodiment of the present invention.

FIG. 4 is an example embodiment of system of sensor units of the present invention.

FIG. 5 is an example embodiment of a method of the present invention.

FIG. 6 is an example embodiment of a method of the present invention.

FIG. 7 is an example embodiment of a method of the present invention.

Like reference numbers and designations in the various drawings indicate like elements.

### DETAILED DESCRIPTION

As shown in FIG. 1, a sensor unit 10 comprises a top cover 12, a load sensor 14 a circuit board 16, and bottom plate 20. Top cover 12 may further comprise retention ring 13, stability flange 15, and raised sidewalls 17. Bottom plate 20 may further comprise retention rings 21 and 23. The top cover 12 and bottom plate 20 are configured to connect and form a single unit. Connection can be by snap connectors, friction connectors, screws, brackets or any other suitable connection. Retention ring 13 of top cover 12 can be configured to work cooperatively with retention ring 21 and 23 of bottom plate 20 to provide proper alignment and connection between top cover 12 and bottom plate 20. Snap connecting means, friction connecting means, screw holes, and the like can be incorporated into the structure of the retention rings 13, 21 and 23 to provide a secure assembly of the sensor unit 10. In some embodiments one or more O-rings are provided in and around the retention rings 13, 21, and 23 to ensure moisture or other contaminants do not enter the sensor unit 10. In some embodiments, when bottom plate 20 is attached to top cover 12, a watertight interior space 18 is provided.

Sensor unit 10 can be secured to a surface for monitoring load conditions on that surface in any number of means, including providing screw fittings in stability flanges 15 to screw the sensor unit 10 to the monitored surface. In one embodiment a bracket is provided to mount around stability flange 15, there by facilitating easy removal, maintenance or replacement of senor unit 10.

Top cover 12 and bottom plate 20 may comprise a durable plastic or composite material resistant to temperature, moisture, UV degradation, the effects of wind, rain, snow, hail, sleet, ice, dust, and insects and other pests.

In one example implementation sensor 14 is not in direct contact with the ambient environment but instead is in contact with load transfer assembly 19 which is integral to top cover 12. In such an arrangement, sensor 14 is protected from blunt strikes as experienced by hail and sleet, as well as uneven loading, for example from an inadvertent step by a person walking on the surface.

FIG. 2 shows a top view of one example implementation of a sensor unit 10 comprising a load sensor cover 14 and one or more solar panels 25. Sensor unit 10 can be provided with or without sensor solar panels 25.

FIG. 3 shows an internal top view of bottom plate 20 including circuit board 16, sensor 14, Wi-Fi processor 26, secondary processor 27, and one or more batteries 28. Load sensor is configured to detect a static or dynamic load, and can be any standard load cell. Various details of a load sensor are disclosed in International Publication No. WO 2011/133942 A2, entitled Surface Mounted Monitoring System, incorporated herein by reference and included with this filing as Enclosure 1. Circuit board 16 also includes a one or more processors, such as Wi-Fi processor 26 and secondary processor 27. In some embodiments, processors associated with circuit board 16 can be GPS enabled, control secondary sensors such as time, temperature, barometric pressure, dew point, humidity, pollen count, UV intensity, contaminant levels, chemical levels, radiological levels and the like. Circuit board 16 may further include any number of alarms and indicators, such as visual indicators in the form of lights, flags, barber poles, or tabs and audio indictors such as bells, alarms, sirens, or speakers. Such indicators can be used to indicate operational status, battery life, connectivity to a network, presence of an alarm condition, for example a load within or over a specified parameter.

Load sensor 10 is configured to operate in a network or array of load sensors to measure the load over a specified area, such as a large flat roof or other structure concerned with loads due to snow, standing water, wind or other forces.

FIG. 4 illustrates an example implementation of a sensing system 400 including an array 412 of one or more load sensors 410 in communication with a server 414 and network 416. Array 412 includes one or more load sensors to measure a load condition, or any other desired condition. Load sensors 412 are in communication via wireless network with system server 414. The wireless network can use any wireless standard including Bluetooth, Wi-Fi or Zigbee. ZigBee is a specification for a suite of high level communication protocols using small, low-power digital radios based on an IEEE 802 standard for personal area networks.

Server 414 is in communication with a larger network 416, such as the Internet, a cellular network, or a private network. Server 414 can send information received from sensor array 412 to other terminals and users also connected to the network and can configure messages to be received by users at a telephone 421, cellular telephone or smart phone 422, computer terminal 423, or a tablet or other computing device 424. Messages and information can be sent in the form of an e-mail, an instant message, a telephone call, a posting to a webpage, a page, or any other network based communication. Server 414 can also receive messages and information over the internet such as system configuration commands and instructions initiated by a system administrator (e.g., turn sensors on, turn sensors off, change sensor reporting parameters, requests for historical or real time reports pertaining to sensor readings, sensor operation or maintenance, etc.), or information of general relevance to the operating environment of the sensor array (e.g., weather data).

In one example of an operating system, sensor array 412 detects an alarm condition, such as a load condition within a specified range and the sensor or sensors detecting the alarm condition establish a connection over the wireless network with server 414 and report specified information such as the sensor ID, alarm condition triggered, load measurement, battery life, etc. Server 414 then sends a report to specified users over network cloud 416.

FIG. 5 illustrates an example implementation of a server (such as server 414 in FIG. 4) acting as a base station coordinator to manage the operation and data collection capabilities of the sensor array.

Upon initialization, the base station coordinator initializes its network stack and checks for the presence of an existing network. If an existing network is detected, the base station coordinator rejoins this network. If an existing network is not detected, it forms a new network and joins this new network.

Upon joining a network, the base station coordinator checks if any messages have been received from the network. If a network message has been received, the base station coordinator performs various functions depending on the type of message received.

If the network message pertains to sensor data from a particular node, the base station coordinator extracts the sensor data from the message, updates its database with the new sensor data, and resets the timeout value of the sensor node.

If the network message pertains to the syncing of a sensor node, the base station coordinator sends a “sync ready” message to the sensor node, acknowledging that the base station coordinator is ready for syncing. The base station coordinator then adds the address of the sensor node to the address table, and resets the timeout value of the sensor node.

If the network message pertains to sensor polling, the base station generates a just-in-time (JIT) message directed at a particular sensor node, requesting that the sensor node send a response . The base station sends the JIT message and awaits a response.

If the base station coordinator did not receive a message, the base station determines if a serial command has been sent from the MSP430 microcontroller. If a serial message has been received, the base station coordinator performs various functions depending on the type of message received.

If the serial message pertains to a request for network joining authorization, the base station controller allows joins to the network for a pre-determined period of time. For instance, the base station controller may allow join to the network for a period of 60 seconds.

If the serial message pertains to changing the settings of a sensor node, the base station coordinator creates a JIT message directed at a particular sensor node, indicating that particular parameters or settings need to be changed on the sensor node. The base station sends the JIT message and awaits a response.

If the serial message pertains to removing a sensor node from the network, the base station coordinator removes the address of the sensor node from the address table.

If the base station coordinator did not receive a serial message from the MSP430 microcontroller, the base station coordinator determines if any of the connected sensors nodes have exceeded a pre-determined timeout period. If so, the addresses of any timed out sensor nodes are removed from the address table. If not, no addresses are removed.

Upon completion of any of the above tasks, data relating to the completed task is sent to the MSP430 microcontroller for additional processing, transmission to other system components, or broadcast to other systems.

FIG. 6 illustrates an example implementation of a sensor board end device to collect and transmit sensor data from the sensor node and to manage the power saving functions of the sensor node.

Upon initialization, the sensor board end device initializes its network stack and attempts to rejoin its last joined network. If the rejoin attempt is unsuccessful, the sensor board enters a low-power sleep state. After a pre-determined period of time, the sensor board will awake and reattempt to network a network.

The sensor board may also be manually awoken by a user through a button press on the sensor board. If the sensor board is successfully connected to a network, the sensor board will leave the network and reenter the sleep sate. On the other hand, if the sensor board is not connected to a network, it will attempt to join a new network.

If during this process the attempt to join a network is successful, the sensor board sends a sync message to the base station coordinator indicating that the network join was successful, then waits for a “sync ready” response message from the base station coordinator. If the “sync ready” response message is not received after a pre-determined length of time, the sensor board reenters the sleep state.

If the “sync ready” response message is successfully received, the sensor enters a network-connected sleep state. During the network-connected sleep state, the sensor board will periodically check if a pre-determined sample time has elapsed. If it has, the sensor board awakes from the low power state and uses an analog-to-digital converter (ADC) to convert analog data from its sensor component into a digital representation.

The sensor board then determines if a pre-defined alarm level has been exceeded. In some embodiments, this alarm level may correspond to a pre-determined threshold of force that is applied to the sensor component, indicating an unsafe amount of load on the sensor.

If this alarm level has been exceeded, the sensor board transmits the sensor data to the base sensor coordinator and awaits the receipt an acknowledgement message. If an acknowledgement message is not received, the sensor board continues to retry sending the sensor data until an acknowledgement message is received, or until it exceeds a pre-determined number of failed transmission attempts. If the pre-determined number of failed transmission attempts is exceeded, the sensor board leaves the network and enters the sleep state described above.

If instead an acknowledgement message is received, the sensor board determines if the acknowledgement message includes a request for data polling. If so, the sensor continuously acquires data and transmits data in a data polling state for a predetermined amount of time, or until a message is received to discontinue data polling. If data polling is not requested, or if data polling has ended, the sensor board returns to the network-connected sleep state.

If, during the network-connected sleep state, the sensor board determines that if a pre-determined sample time has not yet elapsed, or if the sensor board determines that ADC-converted data does not exceed the alarm level, the sensor board determines if a pre-determined data transmission time has elapsed. If not, the sensor board enters the network-connected sleep state. If so, the sensor board is awoken from network-connected sleep state (if necessary), uses the ADC to convert analog data from its sensor component into a digital representation, and attempts to send the digitized sensor data to the base station controller, in the manner described above.

In some embodiments, each of the pre-determined values may be set and altered through JIT messages sent from the base station controller. These pre-determined values may include the time between sensor samples, the time between data transmission, the acknowledgement wait time, the alarm level threshold, the data polling period, and the “sync ready” wait time.

The low power sleep states described above may be implemented using low power mechanisms described in various standard networking specifications. For example, various implementations of low power Wi-Fi networking are described by the IEEE Standards Association in IEEE 802.11-1997, IEEE 802.11a-ae, and IEEE 802.11 DCF, including the use of power save mechanisms (PCMs) to transition devices between a sleep state and an active transmission state. Other low power networking implementations are described by Bluetooth SIG in Bluetooth Specification v4.0 and the IEEE Standards Association in 802.15.4.

FIG. 7 illustrates an example method by which a user can monitor load conditions measured at one more sensors in a sensor array. Users can access sensor statistics and historical information for each sensor in the array. Users can adjust sensor settings for all sensors in the array, groups of sensors in the array, or individual sensors in the array. Sensor settings can include measurement type (e.g., load, temperature, barometric pressure, vibration, humidity, dew point, noise level, contaminant or particulate level, etc.). Sensor settings can also include reporting or activation intervals or alarm values. Users can also add sensors to the array, remove sensors from the array, establish operating and reporting parameters and the like.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus comprising:
a protective top cover having a load transfer assembly;
a bottom plate attachable to the top cover, the bottom plate including a circuit board comprising;
a load sensor,
a power source; and
a wireless processor;
wherein the circuit board is configured on the bottom plate such that the load transfer assembly of the top plate is in contact with the load sensor.

2. A method performed by data processing apparatus, the method comprising:
periodically monitoring the load condition over a specified area using one or more networked load sensors;
connecting a load sensor with a local network, receiving at sensor base station a load condition measured by at least one load sensor;
processing the load condition and determining whether such load condition is within a specified parameter; and
reporting the load condition to a user over a network.

3. A computer storage medium encoded with a computer program, the program comprising instructions that when executed by data processing apparatus cause the data processing apparatus to perform operations comprising:
periodically monitoring the load condition over a specified area using one or more networked load sensors;
connecting a load sensor with a local network, receiving at sensor base station a load condition measured by at least one load sensor;
processing the load condition and determining whether such load condition is within a specified parameter; and
reporting the load condition to a user over a network.

4. A system comprising:
a base station;
a sensor array having one or more load sensor, wherein the load sensors comprise a protective top cover having a load transfer assembly;
a bottom plate attachable to the top cover, the bottom plate including a circuit board comprising;
a load sensor,
a power source; and
a wireless processor;
wherein the circuit board is configured on the bottom plate such that the load transfer assembly of the top plate is in contact with the load sensor;
wherein the load sensors are in wireless communication with a base station server;
wherein the base station server receives periodic load condition reports from the load sensors in the sensor array, processes the load conditions into a user readable report and transmits the user readable report to a user terminal over network.

5. The system of claim 4, wherein the one or more computers comprise a server operable to interact with the load sensor through a data communication network, and the load sensor is operable to interact with the server as a client.
